(19) United States
(12) Patent Application Publication
(10) Pub. No.: US 2004/0037734 A1
(43) Pub. Date: Feb. 26, 2004

(54) Method for removal of mold from a structure

(76) Inventor: Patrick J. Toomey, Lilburn, GA (US)

Correspondence Address: NEEDLE & ROSENBERG, P.C., SUITE 1000, 999 PEACHTREE STREET, ATLANTA, GA, 30309-3915, US

(21) Appl. No.: 10/226,937

(22) Filed: Aug. 23, 2002

(51) Int. Cl. A01N 1/00

(52) U.S. Cl. 422/1

(57) ABSTRACT

A system and method for removing mold from a structure in which mold has formed in at least one cavity in the structure. The method comprises the steps of identifying the cavity having at least one area of moisture accumulation, forming a bore through a surface at the structure in communication with the cavity, and evacuating the mold therefrom. The mold is exhausted outside the structure.

### BACKGROUND

1. Field of the Invention

The present invention relates to the removal of mold from a building, house, or other structure, more particularly, to the removal of mold from at least one interior cavity of the structure.

2. Description of Related Art

Molds, a subset of the fungi, are ubiquitous on our planet. Fungi need external organic food sources and water to be able to grow. Molds can grow on cloth, carpets, leather, wood, sheet rock, insulation, or other food source when moist conditions exist. Because molds grow in moist or wet indoor environments, it is possible for people to become exposed to molds and their products, either by direct contact on surfaces, or through the air, if mold spores, fragments, or mold products are aerosolized.

Many molds reproduce by making spores, which, if they land on a moist food source, can germinate and begin producing a branching network of cells called hyphae. Molds have varying requirements for moisture, food, temperature and other environmental conditions for growth. Indoor spaces, such as interior cavities of a structure, that are wet, and have organic materials that mold can use as a food source, can and do support mold growth. Mold spores or fragments that become airborne can expose people indoors through inhalation or skin contact.

Molds can have an negative impact on human health, depending on the nature of the species involved, the metabolic products being produced by these species, the amount and duration of individual's exposure to mold parts or products, and the specific susceptibility of those exposed. The health effects generally fall into four categories. These four categories are allergy, infection, irritation, and toxicity.

The most common response to mold exposure may be allergy. People who are atopic, that is, who are genetically capable of producing an allergic response, may develop symptoms of allergy when their respiratory system or skin is exposed to mold or mold products to which they have become sensitized. Sensitization can occur in atopic individuals with sufficient exposure. Allergic reactions can range from mild, transitory responses, to severe, chronic illnesses.

Infection from molds that grow in indoor environments is not a common occurrence, except in certain susceptible populations, such as those with immune compromise from disease or drug treatment. A number of Aspergillus species that can grow indoors are known to be pathogens. There are other fungi that cause systemic infections, such as Coccidioides, Histoplasma, and Blastomyces.

A third group of possible health effects from fungal exposure derives from the volatile compounds (VaC) produced through fungal primary or secondary metabolism, and released into indoor air. Some of these volatile compounds are produced continually as the fungus consumes its energy source during primary metabolic processes. Depending on available oxygen, fungi may engage in aerobic or anaerobic metabolism. They may produce alcohols or aldehydes and acidic molecules. Such compounds in low but sufficient aggregate concentration can irritate the mucous membranes of the eyes and respiratory system. However, just as occurs with human food consumption, the nature of the food source on which a fungus grows may result in particularly pungent or unpleasant primary metabolic products. Certain fungi can release highly toxic gases from the substrate on which they grow. Decreased attention, disorientation, diminished reflex time, dizziness and other effects can also result from such exposures.

Molds can produce other secondary metabolites such as mycotoxins. Mycotoxins are nearly all cytotoxic, disrupting various cellular structures such as membranes, and interfering with vital cellular processes such as protein, RNA and DNA synthesis. Of course they are also toxic to the cells of higher plants and animals, including humans. Mycotoxins vary in specificity and potency for their target cells, cell structures or cell processes by species and strain of the mold that produces them.

Not all molds produce mycotoxins, but numerous species do (including some found indoors in contaminated buildings). Toxigenic molds vary in their mycotoxin production depending on the substrate on which they grow. The spores, with which the toxins are primarily associated, are cast off in blooms that vary with the mold's diurnal, seasonal and life cycle stage. Recently concern has arisen over exposure to multiple mycotoxins from a mixture of mold spores growing in wet indoor environments. Health effects from exposures to such mixtures can differ from those related to single mycotoxins in controlled laboratory exposures. Field exposures of animals to molds show effects on the immune system as the lowest observed adverse effect. It is important to note that almost all mycotoxins have an immunosuppressive effect, although the exact target within the immune system may differ. Many are also cytotoxic, so that they have route of entry effects that may be damaging to the gut, the skin or the lung. Such cytotoxicity may affect the physical defense mechanisms of the respiratory tract, decreasing the ability of the airways to clear particulate contaminants (including bacteria or viruses), or damage alveolar macrophages, thus preventing clearance of contaminants from the deeper lung. The combined result of these activities is to increase the susceptibility of the exposed person to infectious disease, and to reduce his defense against other contaminants. They may also increase susceptibility to cancer.

Toxicity can arise from exposure to mycotoxins via inhalation of mycotoxin-containing mold spores or through skin contact with the toxigenic molds. Among the genera most frequently found in numbers exceeding levels that they reach outdoors are Aspergillus, Penicillium, Stachybotrys, and Cladosporium. Aspergillus species are fairly prevalent in problem buildings. This genus contains several toxigenic species, among which the most important are, A. parasiticus, A. flavus, and A. fumigatus. Aflatoxins produced by the first two species are among the most toxic substances known, being acutely toxic to the liver, brain, kidneys and heart, and with chronic exposure, potent carcinogens of the liver. They are also teratogenic. Symptoms of acute aflatoxicosis are fever, vomiting, coma and convulsions. A. fumigatus has been found in many indoor samples. A more common aspergillus species found in wet buildings is A. versicolor, where it has been found growing on wallpaper, wooden floors, fibreboard and other building material. A. versicolor does not produce aflatoxins, but does produce a less potent toxin, sterigmatocystin, an aflatoxin precursor.

Stachybotrys chartarum has a high moisture requirement, so it grows vigorously where moisture has accumulated from roof or wall leaks, or chronically wet areas from plumbing leaks. It is often hidden within the building envelope, such as within an interior cavity of a building. This mold has a very low nitrogen requirement, and can grow on wet hay and straw, paper, wallpaper, ceiling tiles, carpets, insulation material (especially cellulose-based insulation). It also grows well when wet filter paper is used as a capturing medium. Symtoms from exposure to macrocyclic trichothecenes produced by S. chartarum may include headaches, sore throats, hair loss, flu symptoms, diarrhea, fatigue, dermatitis, general malaise, psychological depression.

Because of the health hazards caused by mold circulating within the occupied spaces of a structure, prudent health practice calls for removal from exposure to the mold through clean up or remediation. While not all species within these mold genera are toxigenic, it is prudent to assume that when these molds are found in excess indoors that they are treated as though they are toxin producing. Mold growth in buildings (in contrast to mold contamination from the outside) always occurs because of unaddressed moisture problems.

Buildings are perfect habitats for mold growth. They typically have multiple sources of food—everything from cellulose-based products to flaked skin will suffice.

They have the appropriate temperature range, from about 40 to 100° F., and have lots of dark crevices, nooks, and crannies, i.e., multiple interior cavities. Further, HVAC systems are especially vulnerable to mold growth. Ductwork and ceiling plenums, aided and abetted by fresh air intakes and fans blowing air around a building are tailor-made conduits for microbes as well as bacteria, like legionella, and volatile organic compounds. Because modern construction techniques allow for and encourage the construction of structures having envelopes that minimize any outside intrusion of external atmosphere into the interior of the home for energy conservation, mold is literally drawn or sucked from the interior cavities of the structure by the structure's HVAC system and then is circulated through the occupied spaces where microscopic bits of mold can hit their suspecting human marks—primarily through inhalation.

In one conventional system, the harmful presence of mold in occupied spaces of the house is “treated” by connecting an expensive mold remediation system into the house's HVAC system. The mold remediation system destroys mold in the air streams immediately before or immediately after processing in a conventional air conditioning unit. While this technique may remove mold from the conditioned air entering the occupied spaces of the home, it fails to remove the underlying source of the mold. That is, mold is still being “sucked” from the interior cavities of the house by the pressure of the HVAC system and is being circulated about the occupied spaces of the house until it is drawn into the return plenums of the HVAC system. Thus, there is a need for a system and method for removing mold from interior cavities of the home so that the occupied spaces of the home may be rendered safe for human occupation.

### SUMMARY

The present invention provides a method and system for removing mold from a structure to make it healthier to inhabit. Accordingly, this new method includes removing mold from within at least one cavity of a structure. In one embodiment, the method includes the steps of first identifying the interior cavity, or cavities, in the structure that have an area of moisture accumulation suitable for the formation of mold. Then, a bore may be formed through a surface of the structure that overlies the identified interior cavity and into communication with the identified interior cavity. This bore may be located at the top or bottom of the identified interior cavity and may also be formed at an angle with respect to the surface of the structure, as desired. Next, mold from within the interior cavity is evacuated via the formed bore. The evacuation step may include evacuating gases which have mold suspended therein or particulate matter which contain mold. Finally, the evacuated mold is exhausted outside of the structure and may be treated as desired.

### BRIEF DESCRIPTION OF THE DRAWINGS

FIG. 1 is a block diagram illustrating the method of the present invention;

FIG. 2 is a block diagram illustrating the method of the present invention;

FIG. 3 is a partial cut-away view of a structure defining a plurality of interior cavities and showing a bore in a surface of the structure and a vacuum source in communication with an identified interior cavity having a moisture accumulation area;

FIG. 4 is a cross-sectional view of an interior cavity of a structure being evacuated; and

FIG. 5 illustrates the present invention in use, showing a vacuum source in communication with a plurality of interior cavities of the structure.

### DETAILED DESCRIPTION OF THE INVENTION

The present invention is more particularly described in the following examples that are intended to be illustrative only since numerous modifications and variations therein will be apparent to those skilled in the art. As used in the specification and in the claims, the singular form “a,” “an” and “the” may include plural referents unless the context clearly dictates otherwise.

In accordance with the purposes of this invention, as embodied and broadly described herein, this invention relates to a method and system for removing mold from a structure in which a plurality of cavities are defined. Referring now to the drawing figures, wherein like reference numerals represent like parts throughout, preferred embodiments of the present invention will now be described.

For purposes of the present invention, the term “mold” includes all of the normal mold genera, such as, for example, typical fungi that are composed of linear chains of cells (hyphae) that branch and intertwine to form a fungus body (mycelium), and mold byproducts, such as, for example, mold spores, particulates, volatile organic compounds (VOCs), and mycotoxins, which are natural organic compounds that can initiate a toxic response in vertebrates. It is known that mold is very adaptable and can colonize dead and decaying organic matter (e.g., textiles, wood, leather, paper) and even damp, inorganic material (e.g., glass, painted surface, bare concrete) if organic material such as dust of soil particles are available. Further, because various mold genera grow and reproduce at different substrate water concentrations and temperatures, mold may occur in a wide variety of habitats, such as, for example, an interior cavity of a structure in which moisture has accumulated.

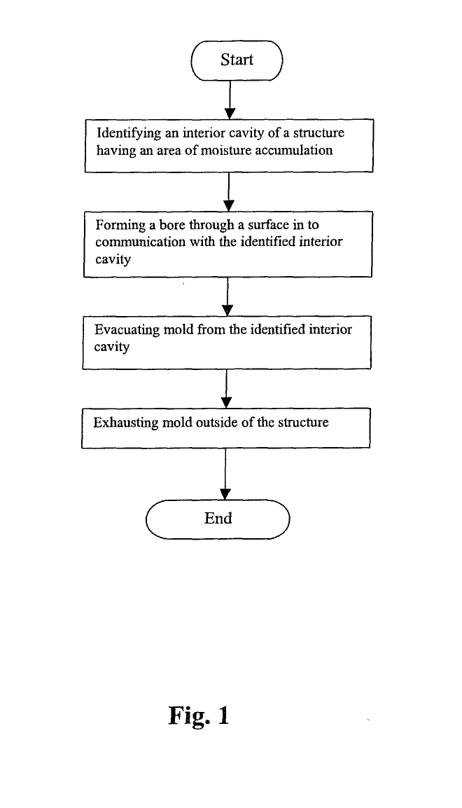

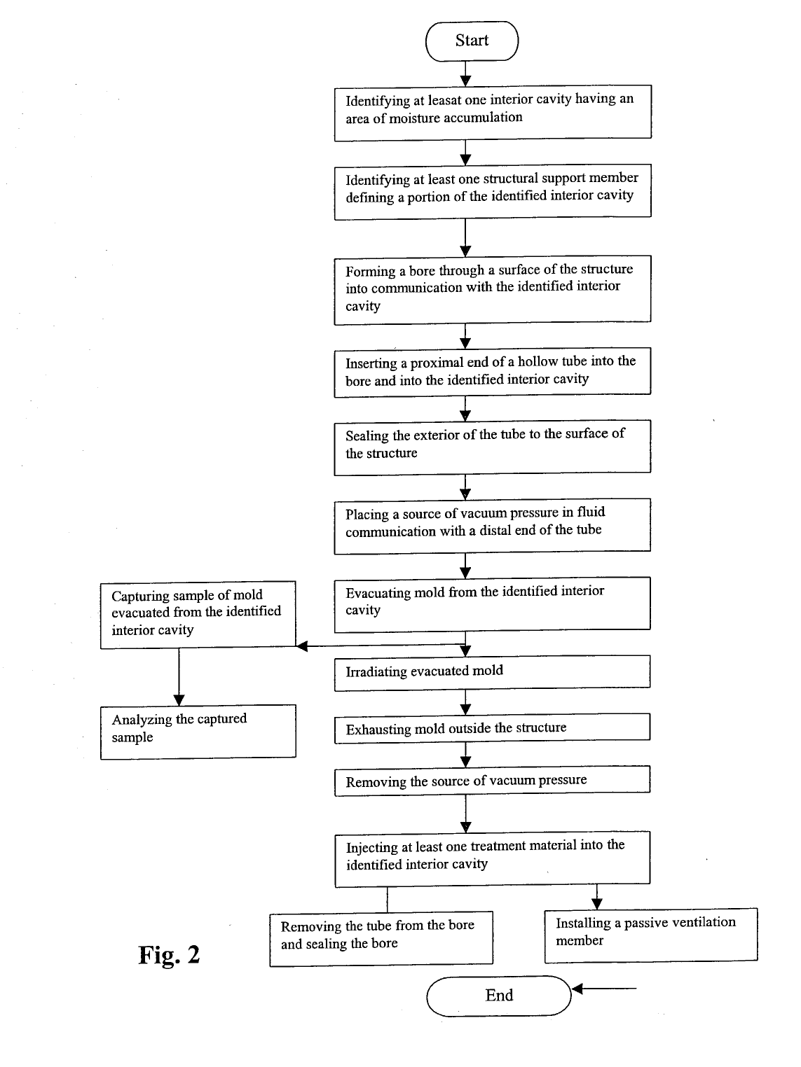

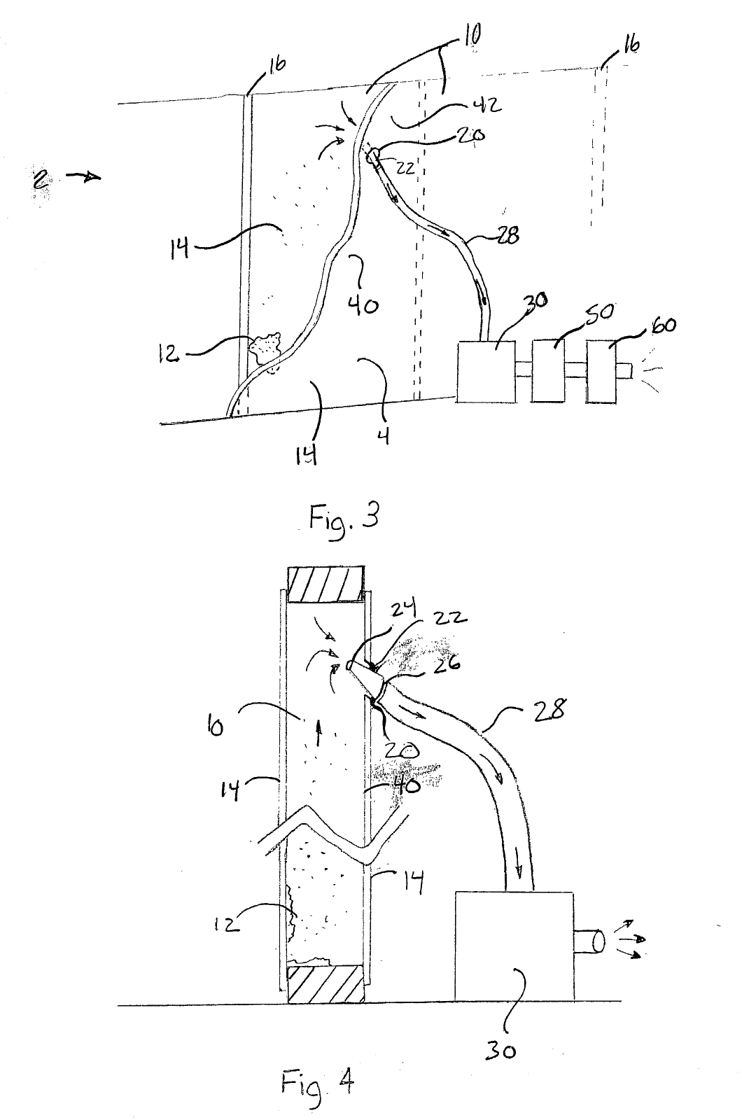

Referring to FIGS. 1-4, the method of the present invention starts with the step of identifying at least one interior cavity 10 of a structure 2 which has a moisture accumulation area 12. Typically, each interior cavity 10 of the structure are defined by a surface 14 and may, as in conventional structure framing, be defined by two surfaces 14 and at least one structural support member 16. As will be apparent to one skilled in the art, the methods and systems of the present invention will work for interior cavities formed in ceilings, floors, or any other defined interior cavity of the structure in addition to the exemplified wall structures shown in FIGS. 3 and 4.

As one will appreciate, moisture is a precursor to mold growth and mold may thrive in a dark moist environment such as is found in an interior structural cavity of a structure in which moisture has accumulated. To identify areas of moisture accumulation in a structure, a visual inspection of the surfaces of the structure may provide evidence of moisture accumulation. However, to more definitively identify the moisture accumulation areas 12 within a structure, the techniques and apparatus described in U.S. Pat. No. 5,886,636 to Toomey are particularly suitable and are incorporated herein by reference. The method outlined in the '636 patent can be used to detect the presence of moisture in a building, house or other structure, even in areas that are not visible to the naked eye. Such areas may include, for example, the inside and outside of a wall, ceiling or floor, or areas of a structure's roof or foundation. Further, the methods outlined in the '636 patent may be used to determine the source of the moisture intrusion problem as either rain, rising damp (i.e., water rising from the ground about the structure), or condensation.

Once the interior cavity 10 is identified, a bore 20 is formed in the surface 14 of the structure that overlies the identified interior cavity so that the bore is in communication with the identified interior cavity. The bore 20 in the surface 14 can be formed in any conventional manner, such as, for example, punching a hole into and through the surface or by a rotary tool using a drill bit or boring bit of the desired size. Prior to forming the bore in the surface, a specific area 40 on the surface of the structure that overlies the identified interior cavity may be identified and at least one structural support member 16 that defines the identified interior cavity 10 may also be identified. This allows the bore 20 to be formed in the specific area 40 of the surface and to be spaced away from the identified structural member.

In the embodiment shown in FIG. 3, the bore 20 is shown formed in an upper portion 42 of the specific area 40, in this example, the upper portion of a wall structure. However, it is contemplated that the bore could be formed in any portion of the specific area, for example, the upper or lower portions 42, 44 of the specific area, as long as the bore provides access to the identified interior cavity that contains a moisture accumulation area. In one example, the bore may be formed so that the bore is angled and extends upwardly toward the upper portion of the specific area as the bore extends into the identified interior cavity. Thus, in this example, the bore 20 may be angled at an angle of approximately 20-80 degrees relative to the surface 14 of the structure.

A proximal end 24 of a hollow tube 22 may then be inserted into and seated in the bore so that the proximal end of the tube extends into the identified interior cavity and a distal end 26 of the tube extends above the specific area 40 on the surface 14 of the structure. In one embodiment, the hollow tube 22 is tapered such that the proximal end of the tube has a smaller diameter than the distal end of the tube. The tapered shape of the tube aids in forming an interference fit between the formed bore 20 and exterior surface of the tube. It is preferred that the exterior surface of tube be sealed relative to the surface 14 of the structure that defines the bore and, more preferably, that a gas-tight seal be formed between the exterior surface of the tube and the surface of the structure that defines the bore. Any conventional sealant may be used, such as, for example, an adhesive or a caulking agent. In another embodiment, a rubber or plastic grommet (not shown) may be placed in the bore prior to installation of the tube to form the gas-tight seal.

Once the bore 20 is formed in the surface 14 of the structure, mold may be evacuated from the identified interior cavity 10 via the formed bore 20 or the tube 22 and subsequently exhausted outside of the structure into the atmosphere. In one embodiment, a source of vacuum pressure 30 is placed into communication the the formed bore. In another embodiment, the source of vacuum pressure 30 is placed into communication with the distal end of the tube. Any conventional source of vacuum pressure may be utilized, such as, for example a regenerative blower or a fan. It is preferred that the source of vacuum pressure 30 provides a negative pressure from 0.01 to 20 pascals; more preferably from 0.1 to 15 pascals; and still more preferably from 0.5 to 10 pascals. As one will appreciate, the source of vacuum pressure creates a negative pressure in the interior cavity relative to the interior spaces of the structure and draws the mold toward the bore to be exhausted to the exterior of the structure. In one embodiment, the source of vacuum pressure 30 is connected to a hollow conduit 28 which is coupled to the distal end of the tube 22, however, as noted above, the vacuum source 30, such as, for example, a micro-fan, may be coupled directly to the formed bore 20. As shown in FIGS. 3 and 4, in the evacuating step, at least one gas disposed within the identified interior cavity that has mold suspended therein and particulates disposed within the identified interior cavity containing mold may be evacuated from the interior cavity 10. These mold containing gases and particulates are then exhausted outside of the structure.

After evacuating the mold, and prior to the step of exhausting the mold into the atmosphere, a portion of the evacuated mold may be captured in a conventional mold sample capture apparatus 50, such as, for example, a conventional culture petri dish, and tested, using conventional laboratory methods, to determine if the captured mold contains toxins such as mycotoxins. Further, while the mold exhausted to the atmosphere would most likely be killed by exposure to natural UV radiation, in an additional step prior to the exhausting the mold into the atmosphere, the evacuated mold may be irradiated by a radiation source 60 so that the mold is destroyed. A conventional radiation source, such as a conventional ultraviolet lamp, may be used to irradiate and destroy the evacuated mold.

In one embodiment, once the desired evacuation is complete, the source of vacuum pressure 30 may be detached from the tube 22 or the formed bore 20. If a tube is used, it may also be removed from the bore. The bore may then be sealed using conventional construction methods and materials to prevent moisture intrusion into the interior cavity through the formed bore. In an alternative embodiment, when the tube 22 is removed from the bore, a passive ventilation member may be inserted into the formed bore into communication with the interior cavity. Preferably, to prevent unwanted moisture intrusion, the passive ventilation member is sealed to the surface to form a liquid-impermeable seal between the surface of the structure and a portion of the exterior surface of the passive ventilation member. The passive ventilation member creates a circulation of air within the interior cavity that allows humidity form within the interior cavity to evaporate outside of the structure. An exemplary passive ventilation member is marketed under the name Speedy and is manufactured by Nervo Clementino.

Alternatively, prior to sealing the bore in the surface of the structure, a treatment material may be injected into the identified interior cavity through the bore. The treatment material acts to destroy any remaining mold and/or to create an environment hostile to the growth of mold. Any conventional treatment material may be used, such as, for example, insecticide, fungicide, and ozone.

To help prevent recurrent growth of mold in the structure, the method may also include the steps of determining the source of moisture intrusion and sealing the source of moisture intrusion. In one embodiment, the step of sealing the source of moisture intrusion is not accomplished until the mold from within the interior cavities of is removed or is being removed. By waiting until the mold is being removed or is removed, the amount of mold that aerosolizes and may thus be readily drawn into the interior of the structure due to the drying conditions in the affected interior cavities is minimized.

As can be appreciated by ones skilled in the art, the actual source of moisture intrusion may not be readily apparent. Water may enter the structure from one location, convert into vapor and travel great distances to accumulate within the structure at a different location. The source of moisture intrusion may be determined through conventional methods, such as, for example, visual inspection of the structure or through the use of the techniques and apparatus described in U.S. Pat. No. 5,886,636 to Toomey. When the source of moisture intrusion is determined, conventional construction methods may be used to correct the construction defect and seal the source of moisture intrusion.

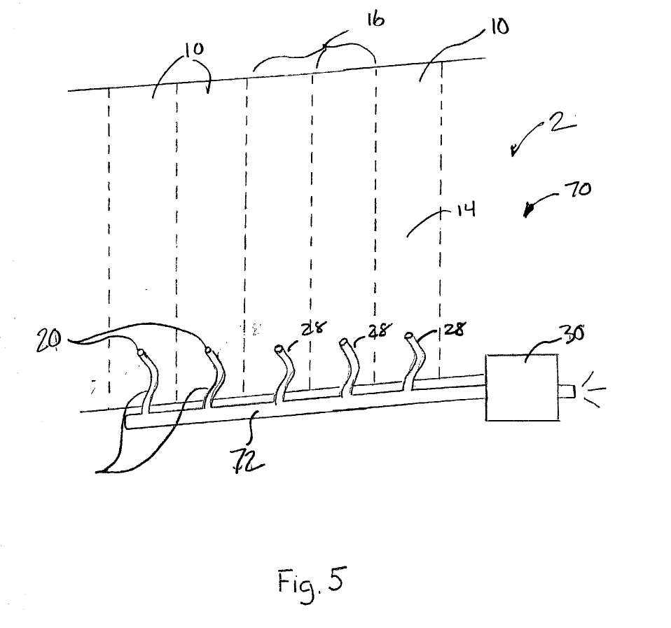

In an alternative embodiment, a system may be put into place to reduce the adverse health effects due to the growth and expansion of the mold within the interior cavities of the structure while the source is being located or the source is being repaired. The system could be run continuously or on a periodic schedule to remove any accumulated mold. As shown in FIG. 5, such a system may allow for the evacuation of a plurality of cavities concurrently. Here, the system 70 includes a plurality of bores 20 formed in surfaces 14 overlies the interior cavities 10. Tubes 22 may be installed into the bores 20 as desired. A source of vacuum pressure 30 is placed into fluid communication with the interior cavities via the bores 20 or tubes 22. In the preferred embodiment, the source of vacuum pressure is connected to the bores 20 or tubes 22 via a trunk line 72 connected to a plurality of conduits 28.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A method for removing mold from a structure in which a plurality of interior cavities are defined, each interior cavity being defined in part by a surface, at least one area of moisture accumulation being formed in at least one interior cavity, whereupon mold is formed in a portion of the area of moisture accumulation, the method comprising the steps of:
a) identifying the at least one interior cavity in the structure having the at least one area of moisture accumulation;
b) forming a bore through the surface in communication with the at least one interior cavity of the structure;
c) evacuating the mold from the at least one interior cavity via the bore; and
d) exhausting the evacuated mold outside of the structure.

2. The method of claim 1, wherein the evacuating step includes the steps of evacuating at least one gas disposed within the at least one interior cavity having mold suspended therein, and evacuating particulates disposed within the at least one interior cavity containing mold from the cavity, and wherein the exhausting step includes the step of exhausting the evacuated gas and particulates outside of the structure.

3. The method of claim 1, wherein the forming step includes the steps of:
identifying a specific area on the surface of the structure that overlies the at least one interior cavity of the structure;
identifying at least one structural support member of the structure that defines in part the at least one interior cavity; and
penetrating through the surface of the structure in the specific area spaced from the at least one structural support member such that the bore is in fluid communication with the at least one interior cavity of the structure.

4. The method of claim 3, the specific area having an upper portion and a lower portion, and wherein the penetration step includes angling the bore such that the bore formed within the surface extends upwardly toward the upper portion as it extends into the at least one interior cavity.

5. The method of claim 4, wherein the bore is angled at an angle of approximately 20-80 degrees relative to the surface.

6. The method of claim 4, wherein the penetration step includes positioning the bore in the upper portion of the specific area.

7. The method of claim 4, wherein the penetration step includes positioning the bore in the lower portion of the specific area.

8. The method of claim 1, wherein the forming step further comprises the step of inserting a hollow tube having a proximal end and a distal end into the bore so that the proximal end of the tube extends into the at least one interior cavity of the structure and the distal end extends above the surface of the structure.

9. The method of claim 8, wherein the hollow tube is tapered such that the proximal end of the tube has a smaller diameter than the distal end of the tube.

10. The method of claim 8, further comprising the step of sealing the tube to the surface of the structure.

11. The method of claim 10, further the step of sealing the tube includes forming a gas-tight seal between the tube and the surface of the structure.

12. The method of claim 10, wherein the evacuating step includes the step of placing a source of vacuum pressure in fluid communication with the distal end of the tube.

13. The method of claim 12, further comprising the steps of:
detaching the source of vacuum pressure from the tube;
removing the tube from the bore in the structure; and
sealing the bore in the surface of the structure against moisture intrusion.

14. The method of claim 12, further comprising the steps of:
detaching the source of vacuum pressure from the tube;
removing the tube from the bore in the structure;
inserting a passive ventilation member into the bore; and
sealing the passive ventilation member to the surface of the structure.

15. The method of claim 1, further comprising the step of injecting treatment material into the at least one interior cavity via the bore.

16. The method of claim 15, wherein the treatment material is selected from a group comprising at least one of: an insecticide, a fungicide, and ozone.

17. The method of claim 1, wherein the evacuating step includes the step of placing a source of vacuum pressure in fluid communication with the bore.

18. The method of claim 17, further comprising the steps of:
detaching the source of vacuum pressure from the bore; and
sealing the bore in the surface of the structure against moisture intrusion.

19. The method of claim 2, further comprising the step of irradiating the evacuated gas and particulates containing mold.

20. The method of claim 2, further comprising the steps of:
capturing at least a portion of the evacuated mold; and
testing at least a portion of the captured mold for toxins.

21. The method of claim 1, further comprising the steps of determining the source of moisture intrusion and sealing the source of moisture intrusion.

22. A method for removing mold from a structure in which a plurality of interior cavities are defined, each interior cavity defined in part by a surface, at least one area of moisture accumulation being formed in at least one interior cavity, whereupon mold is formed in a portion of the area of moisture accumulation, the method comprising the steps of:
a) identifying the at least one interior cavity in the structure having the at least one area of moisture accumulation;
b) penetrating the surface of the structure to form at least one bore, each bore extending through the surface and into communication with the at least one interior cavity of the structure;
c) placing a source of vacuum pressure in communication with the bore to evacuate mold therefrom the at least one interior cavity; and
d) exhausting the evacuated mold outside of the structure.

23. The method of claim 22, wherein at least one gas disposed within the at least one interior cavity having mold suspended therein is evacuated.

24. The method of claim 22, wherein particulates disposed within the at least one interior cavity containing mold are evacuated.

25. The method of claim 22, wherein the penetrating step includes the steps of:
identifying a specific area on the surface of the structure that overlies the at least one interior cavity of the structure;
identifying at least one structural support member of the structure that defines in part the at least one interior cavity; and
penetrating the surface of the structure in the specific area spaced from the at least one structural support member such that the bore is in fluid communication with the at least one interior cavity of the structure.

26. The method of claim 22, further comprising the steps of:
detaching the source of vacuum pressure from the bore; and
sealing the bore in the surface of the structure against moisture intrusion.

27. The method of claim 22, further comprising the step of irradiating the evacuated mold.

28. The method of claim 22, further comprising the steps of determining the source of moisture intrusion and sealing the source of moisture intrusion.

29. The method of claim 22 further comprising the steps of:
capturing at least a portion of the evacuated mold; and
testing at least a portion of the captured mold for toxins.

30. A system for removing mold from a structure in which a plurality of interior cavities are defined, each interior cavity being defined in part by a surface, at least one area of moisture accumulation being formed in at least one interior cavity, whereupon mold is formed in a portion of the area of moisture accumulation, the system comprising:
a hollow tube having a proximal end and a distal end, the tube adapted to be in fluid communication with the at least one interior cavity of the structure so that the proximal end of the tube extends into the at least one interior cavity of the structure and the distal end of the tube extends above the surface of the structure; and
a source of vacuum pressure in fluid communication with the distal end of the tube and the atmosphere outside of the structure so that, in use, mold from the at least one interior cavity are exhausted to the atmosphere.

31. The system of claim 30, wherein the hollow tube is tapered such that the proximal end of the tube has a smaller diameter than the distal end of the tube.

32. The system of claim 30, wherein the hollow tube is positioned so that it is angled relative to the surface of the structure such that the proximal end of the tube is above the distal end of the tube.

33. The system of claim 32, wherein the tube is angled at an angle of approximately 20-80 degrees relative to the surface of the structure.

34. The system of claim 30, further comprising a means for testing a portion of the mold being evacuated from the at least one interior cavity for toxins.
